(19) United States
(12) Patent Application Publication
(10) Pub. No.: US 2009/0090144 A1
(43) Pub. Date: Apr. 9, 2009

(54) Impact Resistant Door Lock

(76) Inventor: Sandor J. Zarnoti, Boerne, TX (US)

Correspondence Address: Ted D. Lee;Gunn & Lee, P.C., Suite 1500, 700 N. St. Mary's Street, San Antonio, TX, 78205, US

(21) Appl. No.: 11/868,282

(22) Filed: Oct. 5, 2007

(51) Int. Cl. E05B 59/00

(52) U.S. Cl. 70/108

(57) ABSTRACT

An impact resistant door lock contained in a housing is shown mounted inside the door to the door frame or wall, but on the opposite side from the hinged mount of the door. Within the housing is a rotating shaft and a fixed shaft. Unidirectional friction springs allow the rotating shaft to only rotate in one direction. Slideable arms mounted on the ends of the rotating shaft, slide to an open position to allow the door to be opened, or rotate to a closed position to prevent the door from being opened. Adjustments allow the impact resistant door lock to be positioned firmly against the structure of the door frame and/or wall to insure a solid abutting relationship.

### BACKGROUND OF THE INVENTION

1. Field of the Invention

This invention relates to impact resistant door locks and, more particularly, to a lock having a slideable arm that moves from an open position to a closed position depending upon rotation of the slideable arm on an axis that can only rotate in one direction due to unidirectional friction springs mounted on the axis.

2. Brief Description of the Prior Art

From almost the beginning of recorded history, locks have been used to keep persons in or out of predetermined areas. For example, in medieval times, castle doors would be closed and various types of locks, bolts, slides, wedges, or other structural devices would be used to prevent someone from opening the castle door. During the medieval times, typically the structures where entry was to be prevented, were massive in nature and required a considerable amount of force to open.

Over the years, as technology advanced and population increased, structures became less and less massive, closer together and much easier to open. Today most homes, apartments or condominiums have outside doors that are hinged on one side and swing inward to open. Typically, the only thing holding the door closed is a door knob lock that may be locked by a single key. Some doors may also be locked with a deadbolt lock extending into the frame. If someone outside wanted inside, all that person would have to do is place some hard kicks at about the waist high level on the door and the door would bust open, even if it had a deadbolt lock.

Another type of lock is the chain lock typically seen inside of a hotel room. These types of locks are bolded into the face of the door frame and on the inside of the door. A simple kick will bust open the door frame despite those locks.

### SUMMARY OF THE INVENTION

It is an object of the present invention to provide an impact resistant door lock.

It is another object of the present invention to mount an impact resistant lock with connections deep into the wall and frame to help prevent the door from being busted opened by kicks or similar type force.

It is yet another object of the present invention to provide a housing mounted deep within the wall and frame that has an arm extending for some distance in front of the door to prevent the door from being opened from outside by human impact such as kicking.

It is yet another object of the present invention to provide a housing mounted on a bracket extending between the door and the door frame, which bracket is attached deep within the door frame and wall. Within the housing is a fixed axis and a rotatable axis substantially parallel to each other and the edge of the door. The rotatable axis only rotates in one direction due to unidirectional friction springs located thereon which only allows rotation only in one direction. A slideable arm that is slideably connected to, but perpendicular to, the rotating axis prevents the door from being opened when the slideable arm is in the close position, but allows the door to be opened when the slideable arm is in the open position. By rotating the rotatable shaft and the slideable arm mounted thereon, the slideable arm can again brace against the door to prevent the door from being forceably opened.

Because each door and door frame are different, the position of the housing with respect to the door and door frame must be adjusted to ensure a firm abutting relationship. The adjustment may be made by adjusting the housing with respect to the bracket, or by adjusting legs extending from the housing.

### BRIEF DESCRIPTION OF THE DRAWINGS

FIG. 1 is a perspective view of the impact resistant door lock as mounted on a door frame with the door in a closed position.

FIG. 2 is an exploded perspective view of the impact resistant door lock.

FIG. 3 is an enlarged view of the impact resistant door lock as shown in FIG. 1 except the door, door frame and wall being cut away for purposes of illustration.

FIG. 4A is a partial sectional view of FIG. 1 taken along section lines 4A-4A.

FIG. 4B is a sequential sectional view the same as FIG. 4A, but with the door partially opened.

FIG. 5 is an enlarged front view of the impact resistant door lock as mounted on the frame and/or wall with the door closed.

FIG. 6 is a cross-sectional view of the impact resistant door lock taken along section lines 6-6 of FIG. 5.

FIG. 7 is a cross-sectional view of the impact resistant door lock shown in FIG. 6 taken along section lines 7-7.

FIG. 8 is a cross-sectional view of the impact resistant door lock shown in FIG. 6 taken along section lines 8-8.

### DESCRIPTION OF THE PREFERRED EMBODIMENTS

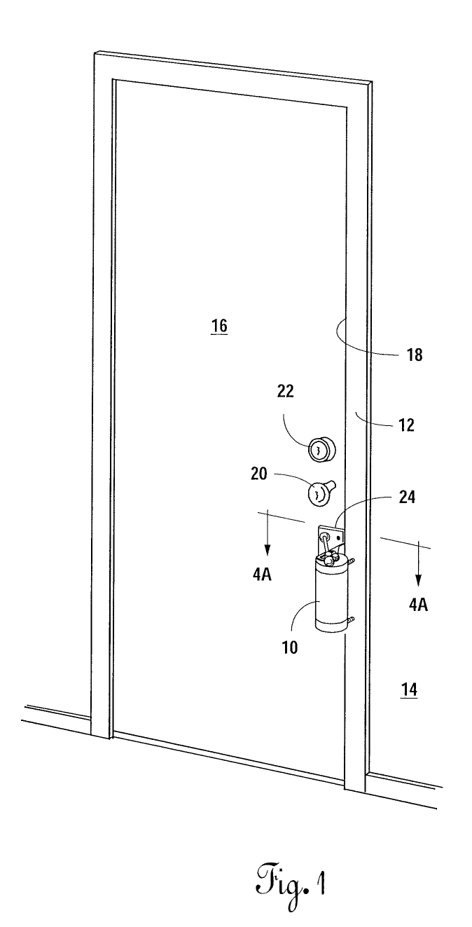

Referring now to FIG. 1, an impact resistant door lock 10 is shown in a perspective view mounted on the door frame 12 and/or wall 14. A door 16 is mounted inside of the door opening 18 in the wall 14. The door 16 has the traditional lockable door knob 20 mounted there through along with a deadbolt lock 22. Also mounted on the front of the door 16 is an impact plate 24.

Without the impact resistant door lock 10, if someone on the outside kicks against door 16, even with the deadbolt lock 22, the door 16 and/or door frame 12 would brake allowing the door 16 to open. With the impact resistant door lock 10, as will be subsequently described, it will require considerably more force to open the door 16.

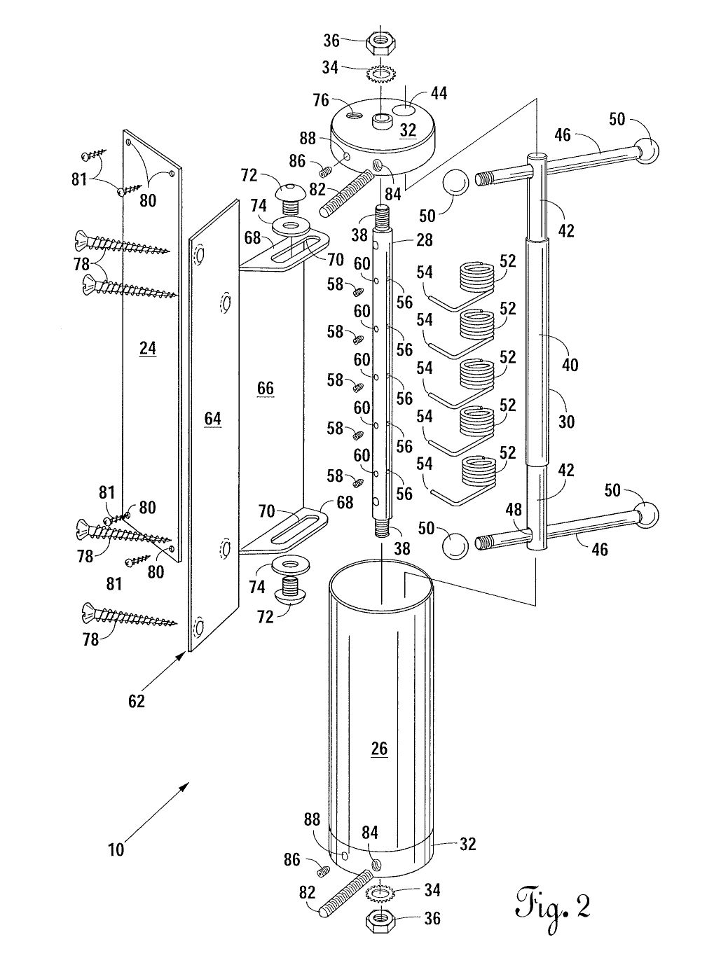

Referring now to FIG. 2, and exploded perspective view of the impact resistant door lock 10 is shown. Inside of a tubular member 26 that may be of any suitable substance, including steel tubing, is located a fixed shaft 28 and a rotatable shaft 30. The fixed shaft 28 extends through end plates 32 and may be held in position by lock washers 34 and nuts 36. The nuts 36 are connected to the threaded ends 38 of the fixed shaft 28.

The rotatable shaft 30 has an enlarged diameter center portion 40 and a reduced diameter end portion or portions 42. The reduced diameter end portions 42 will extend through holes 44 in the end plates 32. Slideable arms 46 which are perpendicular to rotatable shaft 30 will extend through holes 48 at each reduced diameter end portion 42 of the rotatable shaft 30. The slideable arms 46 have threaded balls 50 on either end thereof. Unidirectional friction springs 52 are mounted on the enlarged diameter portion 40 of the rotatable shaft 30. The inside diameter of the unidirectional friction springs 52 is about four to five thousandths smaller than the outside diameter of the enlarged diameter center portion of the rotatable shaft 30. In other words, the unidirectional friction springs 52 have to be expanded slightly to fit on the enlarged diameter center portion 40 of rotatable shaft 30.

Anchor ends 54 of the unidirectional friction springs 52 slide into holes 56 on the fixed shaft 28. Set screws 58 hold the anchor ends 54 of the unidirectional friction springs 52 in their anchor position via threaded holes 60.

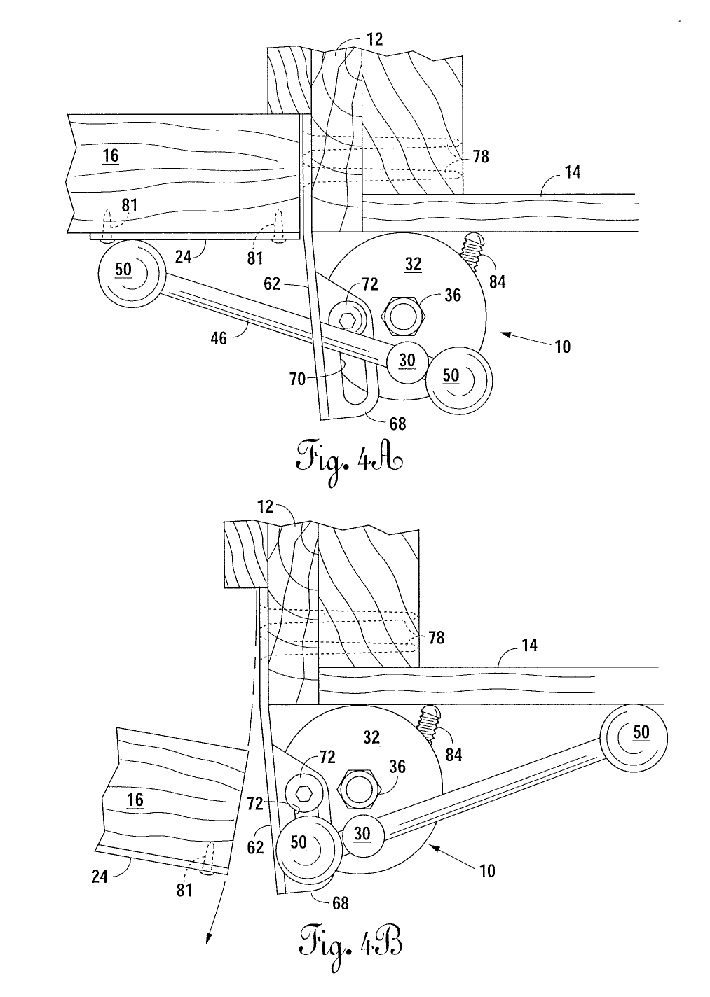

A bracket 62 has a door frame plate 64 and a mounting plate 66 formed with a slight bend there between (see FIGS. 4A and 4B). Each end of the mounting plates 66 is bent inward to form a slotted lip 68 on either end thereof. The slotted lips 68 have slots 70 therein through which mounting screws 72 extend via lock washers 74 into threaded holes 76 of end plates 32. In this manner, mounting screws 72 firmly attach the tubular member 26 with fixed shaft 28, rotating shaft 30 and end plates 32 in position.

Mounting wood screws 78 are long, preferably three to four inches, so the mounting wood screws 78 will extend well through the door frame 12 and into the wall 14. On the other hand, impact plate screws 81 that extend through screws holes 80 can be fairly short of one inch or less because the impact plate screws 81 simply have to maintain the impact plate 24 in position on the door 16.

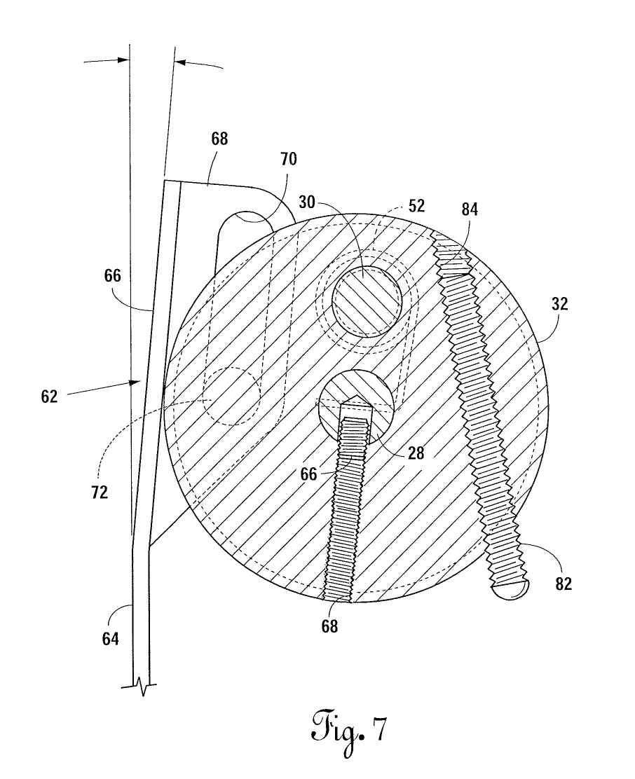

Extending through each end plate 32 at an angle is a threaded leg 82 (see FIG. 7). The threaded legs 82 simply extend through the threaded holes 84 that extend at an angle through end plates 32. Set screws 86 in threaded holes 88 of end plates 32 keep the fixed shaft 28 from turning.

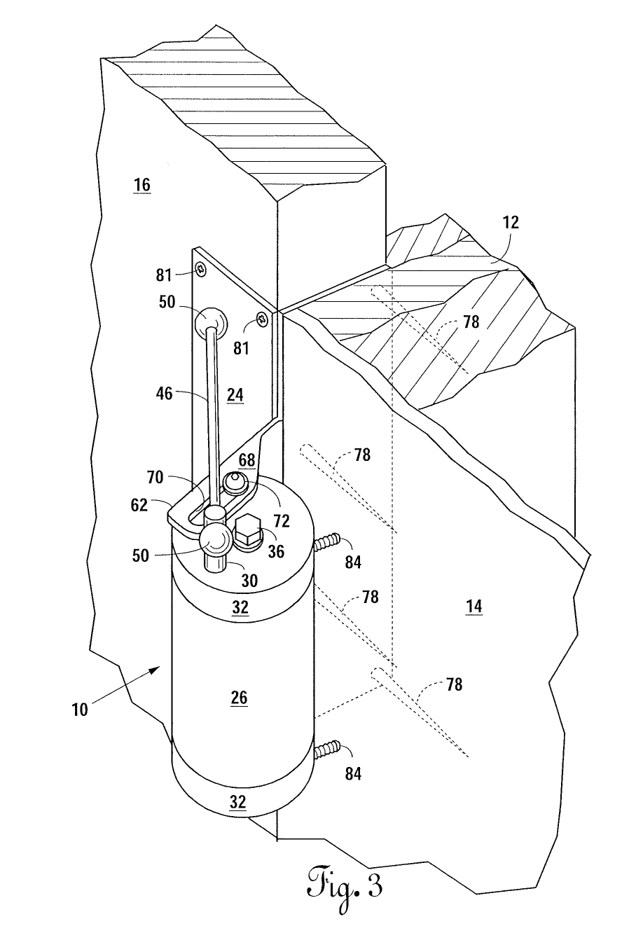

Turning now to FIGS. 3, 4A and 4B in combination, the assembled and mounted impact resistant door lock 10 is shown. The tubular member 26 along with end plates 32 are attached to the bracket 62 by mounting screws 72 threadably connected into the end plates 32. The slots 70 allow the tubular member 26 and end plates 32 to be mounted in an abutting relationship with the wall 14 (see FIGS. 4A and 4B). The threaded legs 84 also assist in making sure there is a good abutting relationship with the wall 14. Mounting wood screws 78 extend well through the door frame 12 into the wall 14 grabbing 2×4's along the way to ensure the entire impact resistant door lock 10 is securely mounted so that the wall 14 would have to be busted apart to open the door 16. The impact plate 24 is attached to the door 16 by impact plate screws 81.

Referring now to FIGS. 3 and 4A, the door 16 is shown in the closed position with the slideable arm 46 also being in a closed position so that one of the threaded balls 50 rests against the impact plate 24. In the position as shown in FIGS. 3 and 4A, to kick open the door 16, would be a difficult. The slideable arms 46 with the threaded balls 50 on the end thereof extend a substantial distance in front of the door 16 and rest against the impact plate 24. The bracket 62 is contained between the door 16 and the door frame 12. Further, the mounting wood screws 78 extend well through the door frame 16 into the wall 14 to screw into 2×4's or other fixed structure that is difficult to break. To open the door 16 by impact as shown in FIGS. 3 and 4A would require busting open a major portion of the wall 14.

Referring to FIG. 4B to open the door 16, slideable arm 46 slides through the rotatable axis 30. The rotatable axis 30 and may even be rotated slightly so that thread ball 50 abuts wall 14 as shown in FIG. 4B. Because the slideable arm 46 and threaded balls 50 on the end thereof are no longer striking the impact plate 24, door 16 is free to open as illustrated in FIG. 4B.

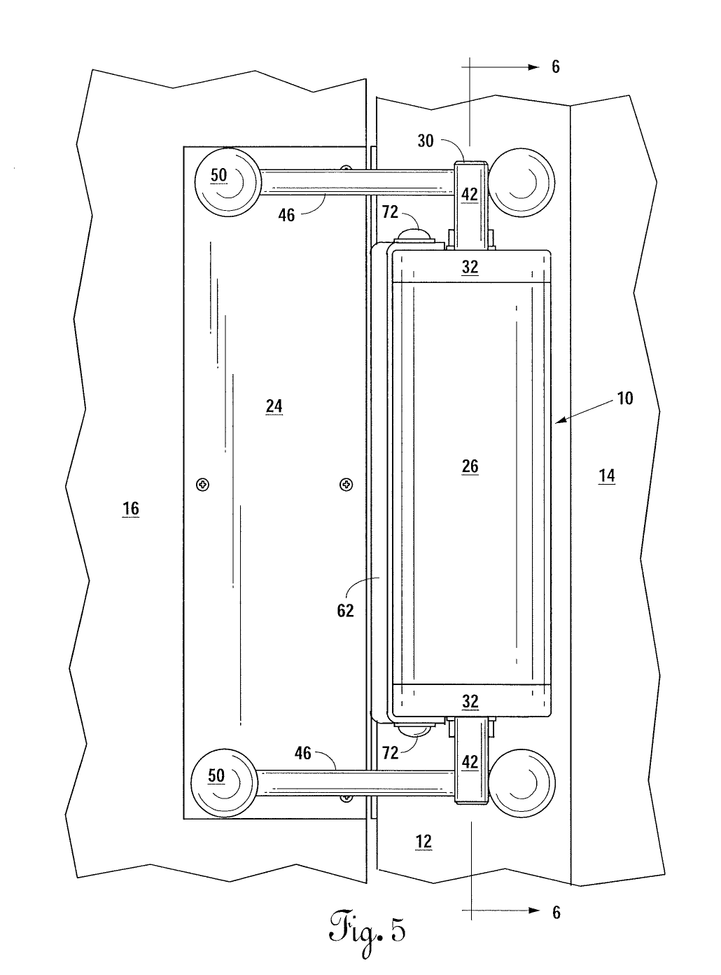

FIG. 5 shows an enlarged front elevation view of the impact resistant door lock 10. The tubular member 26 and end plates 32 are attached to the bracket 62 by mounting screws 72. The slideable arms are shown extended to the closed position so that threaded balls 50 are shown resting against impact plate 24. The reduced end portion 42 of the rotatable shaft 30 are shown extending out of each end of the end plates 32.

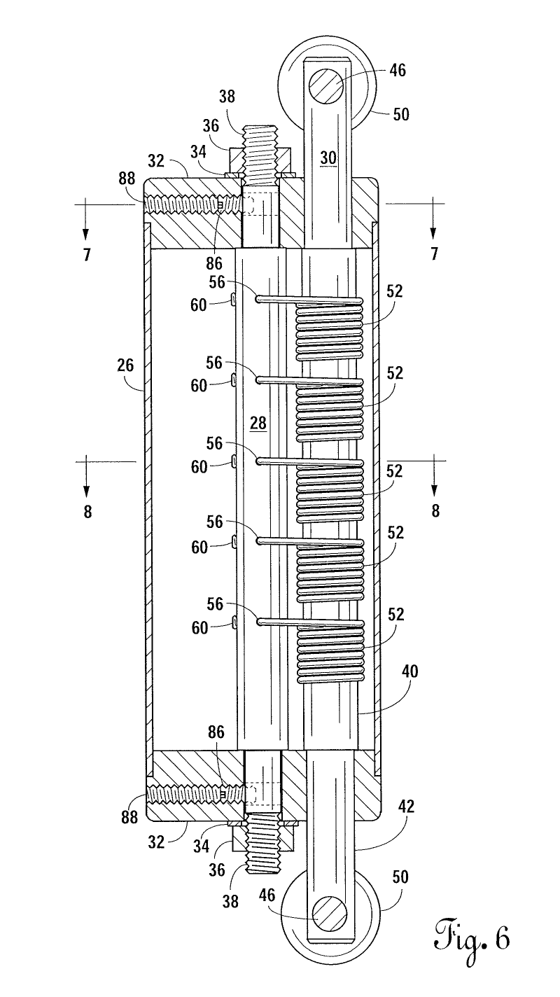

Referring to FIG. 6 which is taken along section lines 6-6 of FIG. 5, the internal workings of the tubular member 26 and the end plates 32 are shown. Each of the unidirectional friction springs 52 are mounted on the enlarged diameter center portion 40 of the rotatable shaft 30. The inside diameter of the unidirectional friction springs 52 is approximately four to five thousandths smaller than the outside diameter of the enlarged diameter center portion 40. Therefore, the unidirectional friction springs 52 have to expanded slightly to allow the enlarged diameter center portion 40 of the rotatable shaft 30 to extend thereto.

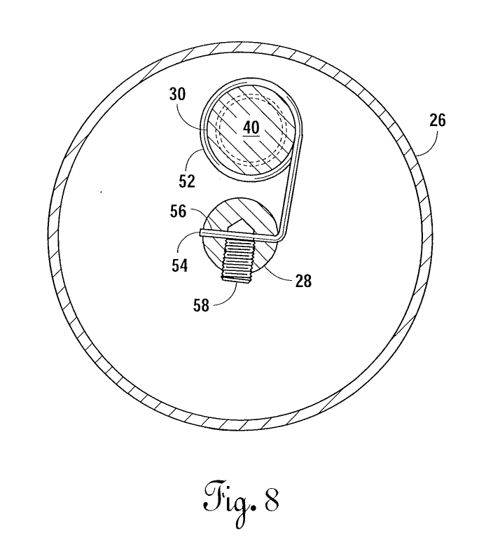

The anchor ends 54 (see FIG. 8) of the unidirectional friction springs 52 extend into a holes 56 of the fixed shaft 28. As can be seen in FIG. 8, a set screw 58 holds the anchor end 54 of the unidirectional frictional spring 52 in the hole 56 of the fixed shaft 28.

Referring back to FIG. 6, because the unidirectional friction spring 52 has an inside diameter that is slightly smaller than the outside diameter of the enlarged diameter center portion 40 of the rotatable shaft 30, if the rotatable shaft 30 turns toward the anchor ends 54, the rotatable shaft 30 is free to rotate. However, if an attempt is made to turn the rotatable shaft 30 in a direction away from the anchor end 54, the unidirectional friction springs 52 will grab the rotatable shaft 30 and not allow rotatable shaft 30 to rotate. Therefore, the rotatable shaft 30 is only free to rotate in one direction. When someone inside wishes to open the door 16, slideable arms 46 must be slid from position 4A to 4B to allow the door 16 to open. Once the door 16 is again closed, slideable arms 46 slides through rotatable shaft 30 as rotatable shaft 30 rotates in the only direction of rotation permissible. Slideable arms 46 are extended until the threaded balls 50 again abut against the impact plate 24.

Not all door frames 12 and walls 14 are positioned the same in relationship to the doors 16. Therefore, to allow some adjustability, slots 70 are provided in the slotted lips 68 of the bracket 62 as shown in FIG. 7. Mounting screws 72 allow for some adjustment to ensure a good abutting relationship against a wall 14 (see FIG. 4A). However, to allow additional adjustments, threaded legs 82 extend through threaded holes 84 in the end plates 32. The threaded legs 82 may be adjusted to ensure there is a good abutting relationship by the impact resistant door lock 10 against the wall 14.

Also, the bracket 62 has enough of a bend between the door frame plate 64 and the mounting plate 66 to ensure that there is clearance for the door 16 to open when the slideable arm 46 is moved to the open position.

By use of the impact resistant door lock 10 described hereinabove, slideable arm 46 extends out a distance in front of the door 16 against impact plate 24 to prevent door 16 from being forceably opened. Because the impact resistant door lock 10 is held in position by long mounting wood screws 78 located between the door 16 through the door frame 12 and into the wood structure of the wall 14. The entire door frame 12, wall 14 plus supporting structure therein would have to be busted before the door 16 would open, which is substantially more difficult than the normal door locks 20 and deadbolt locks 22 contained in most doors.

I claim:

1. An impact resistant door lock to make it harder for a person outside to kick in an inwardly opening door hinged on one side of a door frame, which door frame is built within an external wall, said impact resistant door lock comprising:
a housing;
mounting plates for securing said housing to said door frame opposite from a hinged side of said door, but outside a swing radius of said door;
a fixed shaft extending through said housing;
a rotating shaft extending through said housing and generally parallel to said fixed shaft;
an arm slideably mounted on said rotating shaft, said arm being slideable to a closed position and slideable to an open position;
at least one unidirectional friction spring mounted on said rotating shaft, said unidirectional friction spring having a first end anchored inside said housing, said unidirectional friction spring allowing said rotating shaft to rotate in one direction, but not the opposite direction, so that said arm may alternately slide to said closed position to block opening of said door or slide to said open position to allow opening of said door.

2. The impact resistant door lock as recited in claim 1 wherein said securing of said housing is adjustable to have a firm abutting relationship between said housing and said wall or door frame.

3. The impact resistant door lock as recited in claim 2 wherein said housing has a tubular member with end plates on each end thereof.

4. The impact resistant door lock as recited in claim 3 wherein said mounting plates have slots therein through which said housing is mounted, said slots allowing said housing to be adjustable.

5. The impact resistant door lock as recited in claim 2 further including adjustable legs for said housing to insure said firm abutting relationship between said housing and said wall or door frame.

6. The impact resistant door lock as recited in claim 1 wherein said unidirectional friction spring has an inside diameter slightly smaller than an outside diameter of said rotating shaft on which said unidirectional spring to located, said unidirectional friction spring allowing rotation of said rotating shaft toward, but not against, a direction of winding of said unidirectional friction spring to said first end which is anchored.

7. The impact resistant door lock as recited in claim 6 wherein said outside diameter of said rotating shaft is approximately four to five thousandth of an inch greater than said inside diameter of said unidirectional friction spring.

8. The impact resistant door lock as recited in claim 1 wherein said slideable arm slides through a hole in the end of said rotating shaft.

9. The impact resistant door lock as recited in claim 8 wherein there are two slideable arms, one on each end of said rotating shaft, said slideable arms impacting against said door when in said closed position.

10. The impact resistant door lock as recited in claim 9 wherein said slideable arms have balls on each end thereof to prevent said slideable arms from separating from said rotating shaft.

11. The impact resistant door lock as recited in claim 7 wherein said first end of said unidirectional friction spring is anchored to said fixed shaft.

12. The impact resistant door lock as recited in claim 11 wherein there are a plurality of said unidirectional friction springs.

13. A method of making it hard for a person outside to kick open an inwardly opening door hinged on one side of a door frame built within a small, said method comprising of the following steps:
mounting plates between said inwardly opening door and said door frame with attachments that connect within said wall, an inside portion of said mounting plate extending inside beyond said inwardly opening door when closed;
attaching a housing to said inside portion via a fixed shaft extending through said housing;
rotatably securing a rotatable shaft within said housing generally parallel to said fixed shaft;
frictionally mounting at least one unidirectional friction spring on said rotatable shaft;
anchoring one end of said unidirectional friction spring to said fixed shaft; and
slideably connecting at least one slideable arm generally perpendicular to said rotatable shaft, said slideable arm extending (a) against an inside face of said inwardly opening door when closed and (b) away from said inwardly opening door when open;
said slideable arm resisting an impact opening of said inwardly opening door from said outside person.

14. The method of making it hard for a person outside to kick open an inwardly opening door as recited in claim 13 wherein said attaching step included slotted lips on said inside portion, said slotted lips allowing said housing to be mounted firm against said door frame or wall.

15. The method of making it hard for a person outside to kick open an inwardly opening door as recited in claim 14 including a further step of adjusting legs against said door frame or wall.

16. The method of making it hard for a person outside to kick open an inwardly opening door as recited in claim 13 including a further step of a second mounting of an impact plate on said inside face of said inwardly opening door adjacent one end said slideable arm when said inwardly opening door is in a closed position.

17. The method of making it hard for a person outside to kick open an inwardly opening door as recited in claim 13 wherein said slideably connecting step includes extending said slideable arm through a slide opening in said rotatable shaft, said slideable arms having enlargements on either end thereof to prevent removal from said slide opening.

18. The method of making it hard for a person outside to kick open an inwardly opening door as recited in claim 13 wherein said anchoring step includes a set screw holding said one end of said unidirectional friction spring.

19. The method of making it hard for a person outside to kick open an inwardly opening door as recited in claim 19 wherein there is a plurality of said individual friction springs and said set screws.

20. The method of making it hard for a person outside to kick open an inwardly opening door as recited in claim 13 wherein said housing includes a cylinder with end plates on each end thereof.
